(19) United States
(12) Patent Application Publication
(10) Pub. No.: US 2020/0023684 A1
(43) Pub. Date: Jan. 23, 2020

(54) VEHICLE WHEEL

(71) Applicant: HONDA MOTOR CO., LTD., Tokyo (JP)

(72) Inventors: Yusuke OSAWA, Wako-shi (JP); Toshinobu SAITO, Wako-shi (JP); Youichi KAMIYAMA, Wako-shi (JP)

(21) Appl. No.: 16/510,311

(22) Filed: Jul. 12, 2019

(30) Foreign Application Priority Data
Jul. 17, 2018 (JP) 2018-133911

(51) Int. Cl. B60B 21/12; B60C 23/04; G10K 11/172

(52) U.S. Cl. CPC B60B 21/12; B60C 23/0491; G10K 2210/32272; B60B 2900/133; G10K 11/172

(57) ABSTRACT

In a vehicle wheel including a rim, a sub-air chamber member serving as a Helmholtz resonator, and a tire pressure sensor unit, the sub-air chamber member and the tire pressure sensor unit are integrated with each other to be mounted on the rim via an air valve. The tire pressure sensor unit is preferably integrated with the air valve. The vehicle wheel may be configured such that the sub-air chamber member is connected to the tire pressure sensor unit via a bracket, and the bracket is insert-molded in the sub-air chamber member. Moreover, an edge of the sub-air chamber member may be locked to a well part at an opposite side in a wheel width direction to the tire pressure sensor unit.

### CROSS-REFERENCE TO RELATED APPLICATION

This application is based upon and claims priority from the Japanese Patent Application No. 2018-133911, filed on Jul. 17, 2018, the entire contents of which are incorporated herein by reference.

### BACKGROUND OF THE INVENTION

### 1. Field of the Invention

The present invention relates to a vehicle wheel.

### 2. Description of the Related Art

As conventional art, there is known a vehicle wheel having a Helmholtz resonator disposed on an outer circumferential surface of a well part of a rim (see, e.g., Patent document 1: Japanese Unexamined Patent Application Publication No. 2012-45971). The vehicle wheel disclosed in Patent document 1 has configuration in which vertical walls are formed on the outer circumferential surface of the well part so as to extend in the wheel circumferential direction and the Helmholtz resonator is locked to grooves formed on the vertical walls. The vehicle wheel thus configured makes it possible to easily carry out mounting of the Helmholtz resonator on the rim.

However, the conventional vehicle wheel (see, e.g., Patent document 1) requires cutting and forming at least a pair of grooves on the rim for realizing a mounting structure of the Helmholtz resonator, thus posing a problem in that a manufacturing cost is increased. Accordingly, a vehicle wheel has been demanded which uses an existing structure of the wheel in mounting of the Helmholtz resonator.

The present invention has therefore been made in view of the above problems, and an object of the invention is to provide a vehicle wheel that makes it possible to use an existing structure of the wheel in mounting of a Helmholtz resonator to reduce a manufacturing cost.

### SUMMARY OF THE INVENTION

In order to attain the above object, according to an aspect of the present invention, a vehicle wheel reflecting one aspect of the present invention includes a rim, a sub-air chamber member serving as a Helmholtz resonator, and a tire pressure sensor unit, wherein the sub-air chamber member and the tire pressure sensor unit are integrated with each other to be mounted on the rim via an air valve.

The vehicle wheel reflecting one aspect of the present invention makes it possible to use an existing structure of the wheel in mounting of a Helmholtz resonator to reduce a manufacturing cost.

### BRIEF DESCRIPTION OF THE DRAWINGS

The features and advantages provided by one or more embodiments of the invention will become apparent from the detailed description given below and appended drawings which are given only by way of illustration, and thus are not intended as a definition of the limits of the present invention.

FIG. 1 is a perspective view of a vehicle wheel according to an embodiment of the present invention.

FIG. 2 is an overall perspective view of a sub-air chamber member.

FIG. 3 is a sectional view taken along the line in

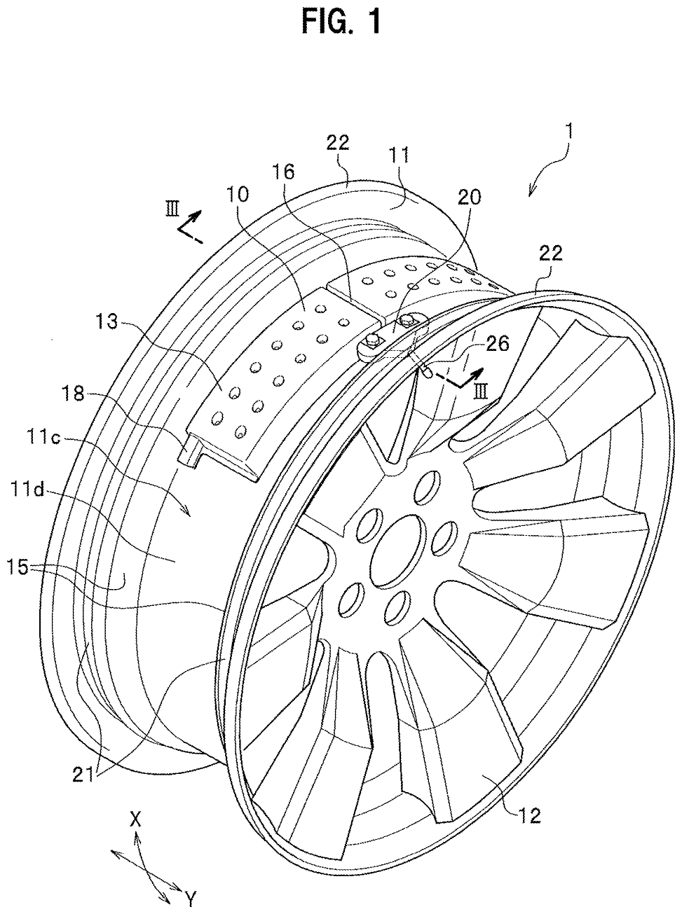

FIG. 1.

FIG. 4 is an overall perspective view of a sub-air chamber member according to a first modification.

FIG. 5 is a sectional view of a sub-air chamber member according to a second modification.

FIG. 6 is a sectional view schematically showing configuration of a vehicle wheel according to another embodiment of the present invention.

### DETAILED DESCRIPTION OF THE PREFERRED EMBODIMENTS

Hereinafter, vehicle wheels according to embodiments of the present invention will be described in detail with reference to the drawings as appropriate. Note that in the drawings to be referred to, reference sign “X” denotes a wheel circumferential direction; reference sign “Y” denotes a wheel width direction; and reference sign “Z” denotes a wheel radial direction. Moreover, in the wheel width direction Y, the center side on an outer circumferential surface of a well part in the wheel is defined as “an inner side in the wheel width direction Y”, and a rim flange side in the wheel is defined as “an outer side in the wheel width direction Y”.

The vehicle wheels according to the embodiments each allow a sub-air chamber member serving as a Helmholtz resonator, and a tire pressure sensor unit, to be integrated with each other to be mounted on a rim via an air valve.

<Overall Structure of Vehicle Wheel>

FIG. 1 is a perspective view of a vehicle wheel 1 according to an embodiment of the present invention.

As shown in FIG. 1, the vehicle wheel 1 according to the present embodiment assumes that it is made of light metal such as aluminum alloy and magnesium alloy. In FIG. 1, reference sign 12 denotes a disk for connecting a rim 11 to a hub (not shown).

The rim 11 includes a well part 11c that is recessed toward a wheel shaft side in the wheel radial direction between bead seats 21 formed on both end parts of the rim 11 in the wheel width direction Y. An outer circumferential surface 11d of the well part 11c is defined by a bottom face of the recessed part and has substantially the same diameter on the wheel shaft throughout the wheel width direction Y.

The rim 11 is provided with a pair of vertical walls 15 each rising from one of both end parts in the wheel width direction Y on the outer circumferential surface 11d of the well part 11c toward a rim flange 22 side. Moreover, the rim 11 rises at the outer side in the wheel width direction Y of the vertical walls 15, via the bead seats 21 to the rim flanges 22.

In FIG. 1, reference sign 10 denotes a sub-air chamber member serving as a Helmholtz resonator, and reference sign 20 denotes a tire pressure sensor unit.

<Sub-Air Chamber Member>

Next, the sub-air chamber member 10 will be described.

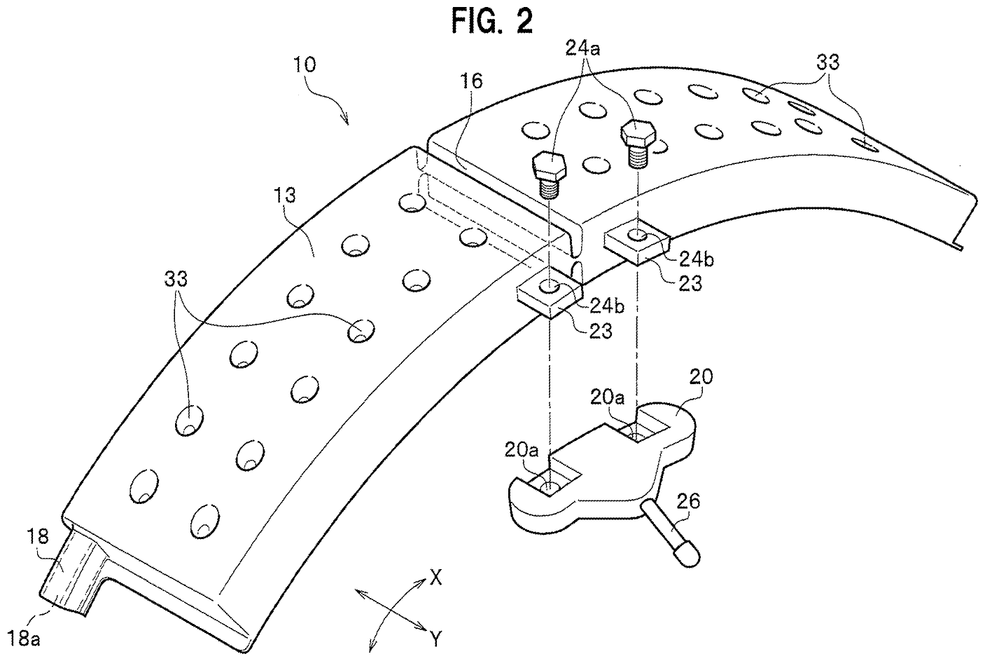

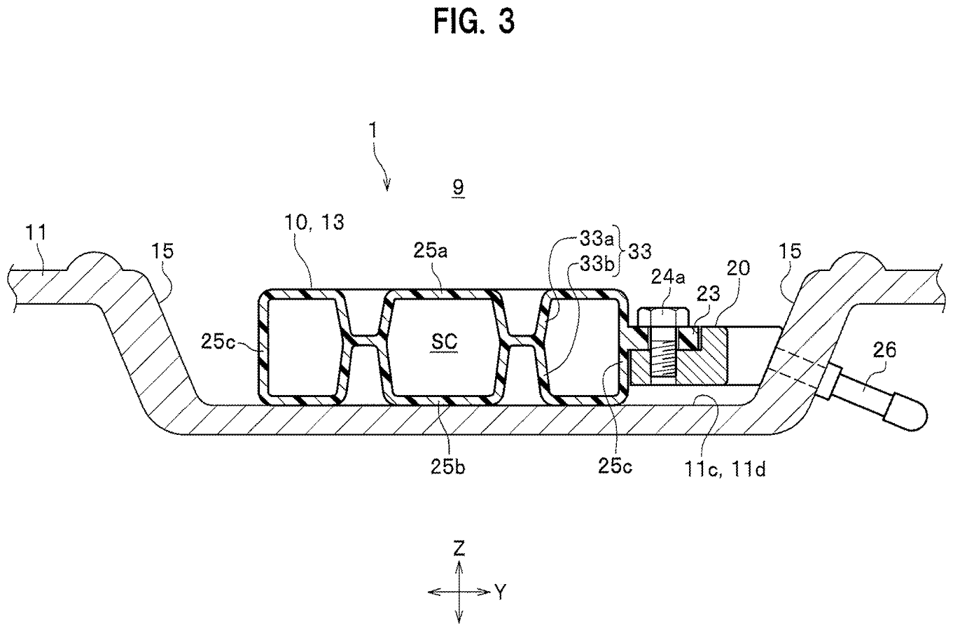

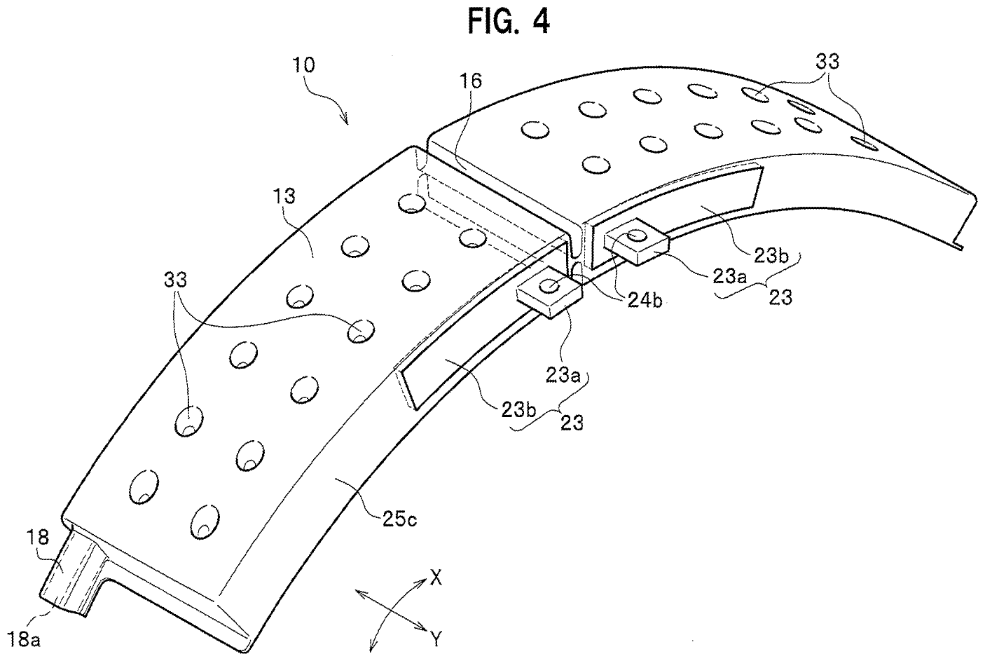

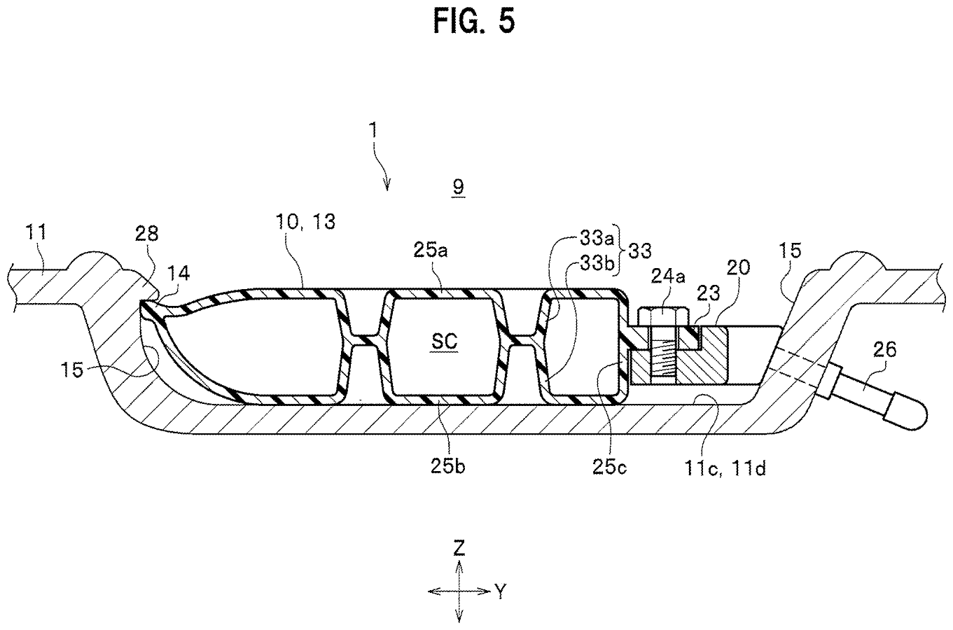

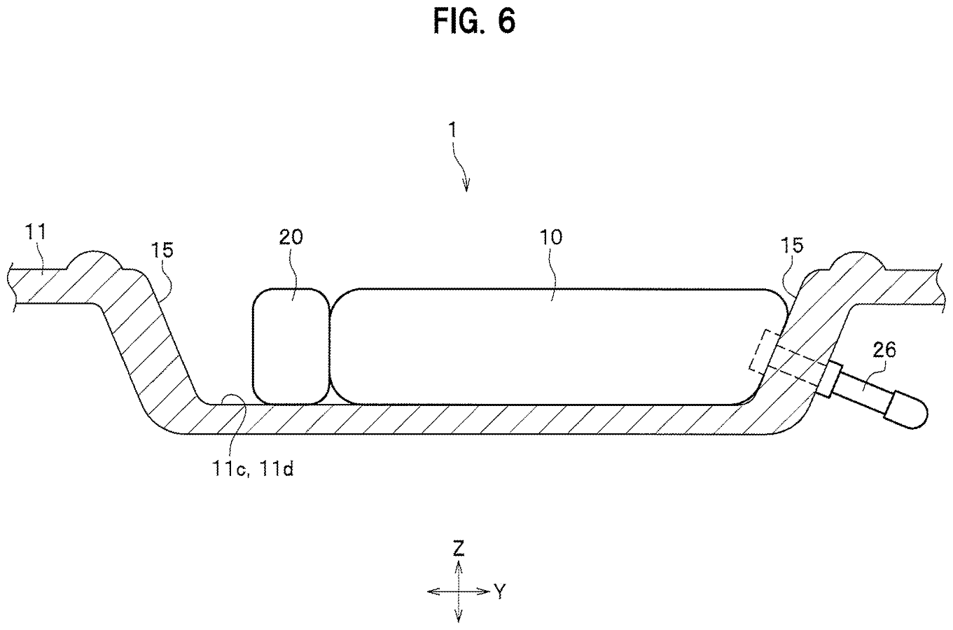

FIG. 2 is an overall perspective view of the sub-air chamber member 10. Illustration of FIG. 2 includes the tire pressure sensor unit 20. FIG. 3 is a sectional view taken along the III-III line in FIG. 1.

As shown in FIG. 2, the sub-air chamber member 10 is a member elongated in the wheel circumferential direction X and includes a main body 13 and a tubular body 18. Note that the sub-air chamber member 10 in the present embodiment assumes a resin molded form.

The sub-air chamber member 10 is configured to have a symmetric shape in the wheel circumferential direction X with respect to a partition wall 16 that extends in the wheel width direction Y at the center of the main body 13.

The main body 13 is curved in a longitudinal direction thereof. In other words, the main body 13 is configured to follow the wheel circumferential direction X when the sub-air chamber member 10 is disposed on the well part 11c (see FIG. 1).

The main body 13 has a hollow part inside. The hollow part (not shown) forms a sub-air chamber SC (see FIG. 3) as described later. The hollow part is divided by the partition wall 16 into two parts in the wheel circumferential direction X.

Moreover, the main body 13 is provided with brackets 23 as shown in FIG. 2. The brackets 23 are each formed of a plate body that protrudes in the wheel width direction Y from the side face of the main body 13, which is on the disk 12 (see FIG. 1) side. The brackets 23 are provided to form one pair across the partition wall 16 in the wheel circumferential direction X.

Moreover, the brackets 23 are each formed with an insertion hole 24b through which a bolt 24a is inserted.

The bolt 24a inserted through the insertion hole 24b is screwed into a corresponding one of threaded parts 20a of the tire pressure sensor unit 20.

This allows the main body 13 to be integrated with the tire pressure sensor unit 20.

The vehicle wheel 1 according to the present embodiment assumes fastening by the bolt 24a as the joining means for the main body 13 and the tire pressure sensor unit 20 as described above, but the joining means is not limited to the fastening. Accordingly, known joining means such as bonding, welding, and monolithic molding can be preferably used as the joining means for the main body 13 and the tire pressure sensor unit 20.

Incidentally, the brackets 23 in the present embodiment assume that they are formed integrally with the main body 13.

As shown in FIG. 3, the main body 13 has the form of a nearly rectangle elongated in the wheel width direction Y, in cross section orthogonal to the longitudinal direction (the wheel circumferential direction X in FIG. 2).

More specifically, the main body 13 includes a bottom plate 25b that adjoins the outer circumferential surface 11d of the well part 11c and extends in the wheel width direction Y, an upper plate 25a that is disposed so as to face the bottom plate 25b above the outer circumferential surface 11d, and a pair of side plates 25c that rises from both ends in the wheel width direction Y of the bottom plate 25b to be joined to the upper plate 25a.

The bottom plate 25b is composed of a plate body that extends so as to be nearly flat in the wheel width direction Y. The bottom plate 25b is formed to be curved with substantially the same curvature as the outer circumferential surface 11d in the wheel circumferential direction X (see FIG. 1).

The upper plate 25a is curved with a predetermined curvature in the wheel circumferential direction X (see FIG. 1) so as to face the bottom plate 25b with a predetermined distance between the upper plate 25a and the bottom plate 25b.

The side plates 25c are formed to rise from the bottom plate 25b outward in the wheel radial direction Z nearly perpendicularly to the outer circumferential surface 11d of the well part 11c.

Thus, the upper plate 25a, the bottom plate 25b and the side plates 25c are formed to surround the sub-air chamber SC inside the main body 13.

Moreover, as shown in FIG. 2, the main body 13 has a plurality of bridges 33 formed to be arranged at equal intervals in the wheel circumferential direction X. Moreover, the bridges 33 are arranged in two rows in the wheel width direction Y.

As shown in FIG. 3, the bridges 33 are each formed with an upper side connecting part 33a and a lower side connecting part 33b being joined together at a nearly central position between the upper plate 25a and the bottom plate 25b.

Note that the upper side connecting part 33a is formed so as to allow the upper plate 25a to be partially recessed toward the bottom plate 25b. Moreover, the lower side connecting part 33b is formed so as to allow the bottom plate 25b to be partially recessed toward the upper plate 25a.

The bridge 33 thus formed has a nearly cylindrical shape and partially connects the upper plate 25a with the bottom plate 25b. Moreover, the bridge 33 forms circular openings in planar view at corresponding positions in the up-down direction of the main body 13.

Note that in FIG. 3, reference sign 20 denotes the tire pressure sensor unit.

Next, the tubular body 18 (see FIG. 1) will be described. Next, the tubular body 18 (see FIG. 1) will be described.

As shown in FIG. 1, the tubular body 18 is formed at a position biased to the one side (the inner side of the vehicle wheel 1) in the wheel width direction Y on the main body 13 so as to protrude from the main body 13 in the wheel circumferential direction X.

The sub-air chamber member 10 in the present embodiment is formed, as described above, into a symmetric shape in the wheel circumferential direction X with respect to the partition wall 16. Accordingly, although only one tubular body 18 is shown in FIG. 1, the tubular bodies 18 in the present embodiment are disposed to form one pair at positions symmetrical to each other on both end parts in the longitudinal direction (the wheel circumferential direction X) of the main body 13. Incidentally, the tubular bodies 18 forming the pair in the present embodiment are spaced from each other in the circumferential direction at an angle of approximately 90 degrees around the wheel shaft as the center.

As shown in FIG. 2, the tubular body 18 has a communication hole 18a formed inside.

The communication hole 18a allows the sub-air chamber SC (see FIG. 3) formed inside the main body 13 to be communicated with a tire air chamber 9 (see FIG. 3) which is to be formed between the well part 11c (see FIG. 3) and a tire (not shown).

Although the sub-air chamber member 10 thus configured in the present embodiment assumes a resin molded form as described above, it is not limited to the resin molded form, but may be formed of other materials such as metal.

The tire pressure sensor unit 20 (see FIG. 1) in the present embodiment composes a tire pressure monitoring system (TPMS) that autonomously detects data of tire pressures.

The tire pressure sensor unit 20 is integrated with an air valve 26 as shown in FIG. 2. The air valve 26 is directly connected with the tire pressure sensor unit 20 and communicated with an air vent (not shown) provided in the tire pressure sensor unit 20.

Although not illustrated, the tire pressure sensor unit 20 has sensor holes communicated with an inside space, and a tire pressure sensor, a temperature sensor, an acceleration sensor (a centrifugal sensor), a radio signal transmitter and an antenna are arranged in the inside space. The tire pressure sensor unit 20 is adapted to transmit data detected by the sensors through the radio signal transmitter and the antenna to a tire pressure monitoring unit that is arranged at a proper place in the vehicle body.

The air valve 26 integrated with the tire pressure sensor unit 20 thus configured is inserted into a valve inserting hole (not shown) that is bored in the vertical wall 15 on the disk 12 side, and fixed to the rim 11 as shown in FIG. 1.

When the sub-air chamber member 10 configured as described above is assembled with the rim 11 together with the tire pressure sensor unit 20, the sub-air chamber member 10 and the tire pressure sensor unit 20 are first integrated with each other via the brackets 23 as shown in FIG. 2.

Then, the air valve 26 of the tire pressure sensor unit 20 is inserted into and fixed to the valve inserting hole (not shown) of the vertical wall 15, thereby allowing assembly of the vehicle wheel 1 to be completed.

Next, description will be given of operation and effects of the vehicle wheel 1 according to the present embodiment.

The vehicle wheel 1 according to the present embodiment allows the sub-air chamber member 10 and the tire pressure sensor unit 20 to be integrated with each other to be mounted on the rim 11 via the air valve 26. The sub-air chamber member 10 is connected to the rim 11 via the air valve 26.

That is, the vehicle wheel 10 uses an existing structure which is the air valve 26, in mounting of the sub-air chamber member 10. The vehicle wheel 1 thus configured differs from the conventional vehicle wheel (for example, see Patent document 1) and has no need to cut and form grooves for mounting the sub-air chamber member 10 on the rim 11. Accordingly, the vehicle wheel 1 makes it possible to reduce a manufacturing cost as compared to the conventional vehicle wheel (for example, see Patent document 1).

Moreover, the vehicle wheel 1 in the present embodiment uses an air valve integrated tire pressure sensor unit.

The vehicle wheel 1 thus configured makes it possible to easily mount the sub-air chamber member 10 on an existing vehicle wheel to which the air valve integrated tire pressure sensor unit is applied.

Although the embodiment of the present invention has been described above, the present invention is not limited to the above embodiment and can be put into practice in various forms.

Although description has been given of the sub-air chamber member 10 having the brackets 23 formed integrally with the main body 13 in the above embodiment, configuration may be adopted such that the brackets 23 are insert-molded in the sub-air chamber member 10.

FIG. 4 is an overall perspective view of the sub-air chamber member 10 according to a first modification. Note that in FIG. 4, the same constituent element as in the above embodiment is given the same reference sign and thus detailed explanation thereof is omitted.

As shown in FIG. 4, the brackets 23 of the sub-air chamber member 10 are each provided with a mounting part 23a and a reinforcing part 23b. The mounting part 23a and the reinforcing part 23b are disposed to form one pair at positions symmetrical to each other with respect to the partition wall 16.

The mounting part 23a is disposed so as to correspond to one of the threaded parts 20a (see FIG. 2) of the tire pressure sensor unit 20 (see FIG. 2).

The reinforcing part 23b is formed of an elongated rectangular plate body that is insert-molded in the side plate 25c of the main body 13. The reinforcing part 23b extends along the side plate 25c in the wheel circumferential direction X and is connected to the mounting part 23a.

The reinforcing part 23b is in a state of being half-embedded in the side plate 25c and a surface thereof is exposed to a surface of the side plate 25c.

Also in the vehicle wheel 1 (see FIG. 1) having the sub-air chamber member 10 according to the first modification, the sub-air chamber member 10 can be easily mounted on an existing vehicle wheel to which the air valve integrated tire pressure sensor unit is applied.

Although in the above embodiment, description has been given of the configuration such that the sub-air chamber member 10 is supported on the rim 11 via the air valve 26 alone, configuration may be adopted such that a part of the sub-air chamber member 10 is further locked to the well part 11c.

FIG. 5 is a sectional view of the sub-air chamber member 10 according to a second modification, and is a figure corresponding to FIG. 3. In FIG. 5, the same constituent element as in the above embodiment is given the same reference sign and thus detailed explanation thereof is omitted.

As shown in FIG. 5, the sub-air chamber member 10 according to the second modification allows the opposite side part in the wheel width direction Y to the tire pressure sensor unit 20 to be formed as an edge 14 in place of the side plate 25c in the above embodiment. The edge 14 is formed by joining the upper plate 25a and the bottom plate 25b of the sub-air chamber member 10 together and projects outward in the wheel width direction Y. The edge 14 extends in the wheel circumferential direction X (see FIG. 1). Moreover, the edge 14 can be elastically deformed and is locked to the well part 11c by being fitted into the underside of an overhanging part 28 that is formed on an upper part of the vertical wall 15.

Mounting of the integrated object composed of the sub-air chamber member 10 and the tire pressure sensor unit 20 on the rim 11 is carried out as follows. First, with the air valve 26 side of the integrated object being inclined to be directed downward, the air valve 26 is inserted into a valve inserting hole (not shown) of the vertical wall 15. Then, the edge 14 side of the integrated object is pressed by a predetermined pusher to the well part 11c side, and the edge 14 having abutted on the overhanging part 28 is elastically deformed to thereby be fitted into the underside of the overhanging part 28. This allows mounting of the sub-air chamber member 10 and the tire pressure sensor unit 20 on the rim 11 to be completed.

Incidentally, the conventional vehicle wheel (for example, see Patent document 1) requires cutting and forming a pair of grooves for a pair of edges in mounting of the sub-air chamber member 10 as described above.

In contrast, the sub-air chamber member 10 according to the second modification makes it possible to omit one of the pair of grooves as compared to the conventional vehicle wheel.

Accordingly, the vehicle wheel 1 according to the second modification makes it possible to reduce a manufacturing cost as compared to the conventional vehicle wheel.

Although the above embodiment adopts the configuration such that the sub-air chamber member 10 is mounted on the rim 11 via the tire pressure sensor unit 20, the present invention is not limited to this embodiment.

FIG. 6 is a sectional view schematically showing configuration of the vehicle wheel 1 according to another embodiment of the present invention. In FIG. 6, the same constituent element as in the above embodiment is given the same reference sign and thus detailed explanation thereof is omitted.

As shown in FIG. 6, the vehicle wheel 1 allows the tire pressure sensor unit 20 to be mounted on the sub-air chamber member 10 that is mounted on the rim 11 via the air valve 26.

The vehicle wheel 1 thus configured allows location of the tire pressure sensor unit 20 to be not limited by location of the air valve 26, thus making it possible to improve the freedom of arrangement of the tire pressure sensor unit 20.

Although embodiments of the present invention have been described and illustrated in detail, the disclosed embodiments are made for purposes of illustration and example only and not limitation. The scope of the present invention should be interpreted by terms of the appended claims.

### DESCRIPTION OF REFERENCE SIGNS

1: Vehicle wheel; 9: Tire air chamber; 10: Sub-air chamber member; 11: Rim; 11c: Well part; 11d: Outer circumferential surface; 12: Disk; 13: Main body; 14: Edge; 15: Vertical wall; 16: Partition wall; 18: Tubular body; 18a: Communication hole; 20: Tire pressure sensor unit; 20a: Threaded part; 21: Bead seat; 22: Rim flange; 23: Bracket; 23a: Mounting part; 23b: Reinforcing part; 24a: Bolt; 24b: Insertion hole; 25a: Upper plate; 25b: Bottomplate; 25c: Side plate; 26: Air valve; 28: Overhanging part; 33: Bridge; 33a: Upper side connecting part; 33b: Lower side connecting part; SC: Sub-air chamber; X: Wheel circumferential direction; Y: Wheel width direction; Z: Wheel radial direction

What is claimed is:

1. A vehicle wheel comprising a rim, a sub-air chamber member serving as a Helmholtz resonator, and a tire pressure sensor unit, wherein
the sub-air chamber member and the tire pressure sensor unit are integrated with each other to be mounted on the rim via an air valve.

2. The vehicle wheel according to claim 1, wherein
the tire pressure sensor unit is an air valve integrated tire pressure sensor unit.

3. The vehicle wheel according to claim 2, wherein
the sub-air chamber member is connected to the tire pressure sensor unit via a bracket, and
the bracket is insert-molded in the sub-air chamber member.

4. The vehicle wheel according to claim 2, wherein
the sub-air chamber member allows an edge of the sub-air chamber member to be locked to a well part at an opposite side in a wheel width direction to the tire pressure sensor unit.

5. The vehicle wheel according to claim 1, wherein
the tire pressure sensor unit is connected to the sub-air chamber member that is mounted on the rim via the air valve.
